(19) United States
(12) Patent Application Publication
(10) Pub. No.: US 2026/0097578 A1
(43) Pub. Date: Apr. 9, 2026

(54) DISPLAY MODULE

(71) Applicant: BOE Technology Group Co., Ltd., Beijing (CN)

(72) Inventors: Zhao LI, Beijing (CN); Biao GAO, Beijing (CN)

(21) Appl. No.: 19/416,866

(22) Filed: Dec. 11, 2025

Related U.S. Application Data
(62) Division of application No. 18/027,073.

(30) Foreign Application Priority Data
Jan. 25, 2021 (CN) 202110096293.8

(51) Int. Cl. B32B 17/06; B32B 5/18; B32B 7/12; B32B 15/04; B32B 15/18

(52) U.S. Cl. CPC B32B 17/06; B32B 5/18; B32B 7/12; B32B 15/046; B32B 15/18; B32B 2255/26; B32B 2307/412; B32B 2307/54; B32B 2307/7376; B32B 2457/20

(57) ABSTRACT

Provided is a display module including a cover plate assembly. The cover plate assembly includes an ultra-thin glass layer and a first protection layer, wherein the ultra-thin glass layer includes a body portion and a thinned structure disposed at a periphery of the body portion; and the first protection layer includes a wrap portion and a flat portion, wherein the flat portion is connected to the wrap portion, the wrap portion is wrapped around the thinned structure of the ultra-thin glass layer, and the flat portion covers a side surface of the body portion of the ultra-thin glass layer.

This application is divisional application of U.S. application No. Ser. No. 18/027,073, filed on Mar. 17, 2023, the disclosure of which is herein incorporated by reference in its entirety.

### TECHNICAL FIELD

The present disclosure relates to the field of display technologies, and in particular, to a display module.

### BACKGROUND

As display technologies develop, display devices are widely used in many fields, and increasingly high performance of a display is required. A flexible display module features bendability and the like. The flexibility of the display module allows a display apparatus to be bent or folded such that it is convenient to carry and use the display apparatus. However, a cover plate assembly of the display module has low resistance to falling pen impact and collision. Consequently, the cover plate assembly becomes defective or breaks when slightly pressed during use.

### SUMMARY

The embodiments of the present disclosure provide a cover plate assembly and a display module.

A cover plate assembly according to some embodiments of the present disclosure includes an ultra-thin glass layer and a first protection layer. A thinned structure is disposed at an edge of the ultra-thin glass layer. The first protection layer includes a wrap portion and a flat portion. The flat portion is connected to the wrap portion. The wrap portion is wrapped around the thinned structure of the ultra-thin glass layer. The flat portion covers a side surface of the ultra-thin glass layer.

In some embodiments of the present disclosure, the first protection layer is coated on the ultra-thin glass layer.

In some embodiments of the present disclosure, the flat portion has a uniform thickness of 10 μm to 20 μm.

In some embodiments of the present disclosure, the first protection layer is a transparent polyimide (PI) member.

In some optional embodiments of the present disclosure, the ultra-thin glass layer has a thickness of 20 μm to 40 μm.

In some embodiments of the present disclosure, the cover plate assembly further includes a second protection layer disposed on a side, distal to the flat portion, of the ultra-thin glass layer.

In some embodiments of the present disclosure, the second protection layer is a transparent PI member.

A display module according to some embodiments of the present disclosure includes the cover plate assembly according to any foregoing embodiment of the present disclosure.

In some embodiments of the present disclosure, the display module further includes a display panel and a back film. The display panel is disposed on a side, distal to the ultra-thin glass layer, of the flat portion. The back film is disposed on a side, distal to the cover plate assembly, of the display panel, and the back film is configured to adjust a neutral layer position of the display module to the display panel.

In some embodiments of the present disclosure, the back film has a thickness of 50 μm to 100 μm and an elastic modulus of 2 GPa to 5 GPa.

In some embodiments of the present disclosure, the back film adheres to the display panel by a first optical clear adhesive (OCA). The first OCA has a thickness of 5 μm to 25 μm and an elastic modulus of 100 kPa to 300 kPa.

Additional aspects and advantages of the present disclosure are partly provided in the following description, and partly become evident in the following description or understood through the practice of the present disclosure.

### BRIEF DESCRIPTION OF DRAWINGS

The above and/or additional aspects and advantages of the present disclosure will become apparent and easy to understand from the description of the embodiments with reference to the following drawings.

FIG. 1 is a sectional view of a cover plate assembly according to some embodiments of the present disclosure;

FIG. 2 is a schematic diagram of an ultra-thin glass layer of a cover plate assembly according to some embodiments of the present disclosure;

FIG. 3 is a sectional view taken along line A-A in FIG. 2;

FIG. 4 is a schematic diagram of another cover plate assembly according to some embodiments of the present disclosure; and

FIG. 5 is a schematic diagram of a display module according to some embodiments of the present disclosure.

### REFERENCE NUMERALS

100: cover plate assembly;
1: ultra-thin glass layer; 11: body portion; 12: thinned structure;
2: first protection layer; 21: wrap portion; 211: first cover section; 212: connection section; 213: second cover section; 22: flat portion;
3: second protection layer;
1000: display module;
200: display panel; 300: back film; 400: circular polarizer; 500: support member; 501: foam; 502: patterned metal;
600: OCA; 601: first OCA; 602: second OCA; 603: third OCA.

### DETAILED DESCRIPTION

The embodiments of the present disclosure are described below in detail. Examples of the embodiments are shown in the accompanying drawings. Same or similar reference numerals represent same or similar elements or elements having same or similar functions throughout the specification. The embodiments described below with reference to the accompanying drawings are exemplary. These embodiments are merely used to explain the present disclosure, and should not be construed as a limitation to the present disclosure.

A cover plate assembly 100 of a display module 1000 according to some embodiments of the present disclosure is described below with reference to the accompanying drawings.

As shown in FIG. 1, the cover plate assembly 100 of the display module 1000 according to some embodiments of a first aspect of the present disclosure includes an ultra-thin glass layer 1 and a first protection layer 2. Ultra-thin glass features rigidity and good bendability. The ultra-thin glass layer 1 is disposed in the cover plate assembly 100 such that surface hardness of the cover plate assembly 100 is improved, the surface of the cover plate assembly 100 is flatter, and the display panel 200 is protected. Therefore, the cover plate assembly 100 is ultra-thin, and has good bendability and sufficient hardness.

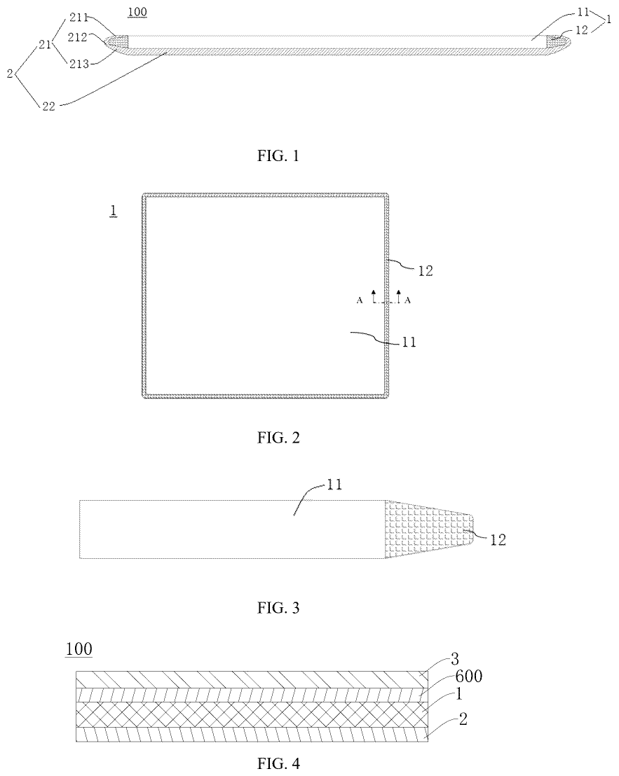

A thinned structure 12 is disposed at the edge of the ultra-thin glass layer 1. Referring to FIG. 2 and FIG. 3, the ultra-thin glass layer 1 includes a body portion 11. The body portion 11 is square (for example, rectangular or quadrate). The thinned structure 12 is disposed on the periphery of the body portion 11. During manufacturing, the thinned structure 12 is formed by polishing the edge of the ultra-thin glass layer 1, to eliminate a defect of the edge of the ultra-thin glass layer 1.

The first protection layer 2 includes a wrap portion 21 and a flat portion 22. The flat portion 22 is connected to the wrap portion 21. The wrap portion 21 is wrapped around the thinned structure 12 of the ultra-thin glass layer 1. Optionally, the cross section of the wrap portion 21 in a direction perpendicular to the ultra-thin glass layer 1 is substantially U-shaped.

In some embodiments of the present disclosure, referring to FIG. 1, the wrap portion 21 includes a first cover section 211, a connection section 212, and a second cover section 213. The first cover section 211 and the second cover section 213 are opposite to each other. The connection section 212 is connected between the first cover section 211 and the second cover section 213. The first cover section 211 covers one side surface of the thinned structure 12. The second cover section 213 covers the other side surface of the thinned structure 12. The connection section 212 covers an edge of the thinned structure 12. Therefore, by disposing the wrap portion 21 and wrapping the wrap portion 21 around the thinned structure 12 of the ultra-thin glass layer 1, the edge of the ultra-thin glass layer 1 is effectively protected, thereby improving the reliability and collision resistance of the ultra-thin glass layer 1, and reducing the risk of edge chipping of the ultra-thin glass layer 1.

The flat portion 22 covers a side surface of the ultra-thin glass layer 1. Referring to FIG. 1, the flat portion 22 covers a side surface of the body portion 11 of the ultra-thin glass layer 1, which improves the overall structural strength of the ultra-thin glass layer 1 and falling ball and pen impact resistance of the cover plate assembly 100.

In the cover plate assembly 100 of the display module 1000 according to the embodiments of the present disclosure, the first protection layer 2 is disposed on the ultra-thin glass layer 1. The wrap portion 21 of the first protection layer 2 is wrapped around the thinned structure 12 of the ultra-thin glass layer 1. The flat portion 22 of the first protection layer 2 covers the side surface of the ultra-thin glass layer 1. In this way, the reliability and collision resistance of the ultra-thin glass layer 1 are improved, and the risk of edge chipping of the ultra-thin glass layer 1 is reduced. In addition, the overall structural strength of the ultra-thin glass layer 1 is improved, and the falling ball and pen impact resistance of the cover plate assembly 100 is also improved. This helps improve the product strength and the service life of the cover plate assembly 100 and the display module 1000 provided with the cover plate assembly 100.

In some embodiments of the present disclosure, the first protection layer 2 is coated on the ultra-thin glass layer 1. Specifically, the first protection layer 2 is coated on the ultra-thin glass layer 1 by a painting process. The process is simple and manufacturing is convenient. This helps reduce manufacturing costs. In addition, the first protection layer 2 is attached to the ultra-thin glass layer 1 such that the protection effect of the first protection layer 2 is improved, thereby further improving the reliability, collision resistance, and falling ball and pen impact resistance of the ultra-thin glass layer 1.

In some embodiments of the present disclosure, the first protection layer 2 is coated through dipping and then curing, or through double-sided printing and then thermal curing, ultraviolet (UV) curing, or the like.

In some embodiments of the present disclosure, the flat portion 22 has a uniform thickness of 10 μm to 20 μm. For example, in some embodiments of the present disclosure, the thickness of the flat portion 22 is 15 μm. An error may be controlled to be ±5 μm. In this way, the falling ball and pen impact resistance of the ultra-thin glass layer 1 can be effectively improved, the overall thickness of the cover plate assembly 100 is controlled, and the bending performance of the cover plate assembly 100 and the display module 1000 provided with the cover plate assembly 100 is ensured.

In some embodiments of the present disclosure, the first protection layer 2 is a transparent (PI) member. In other words, the material of the first protection layer 2 is PI. PI has good thermal stability and mechanical performance, which bonds well with the surface and edge of the ultra-thin glass layer 1, thereby providing good protection for the ultra-thin glass layer 1. In addition, PI is easy to obtain and has low costs.

In some optional embodiments of the present disclosure, the ultra-thin glass layer 1 has a thickness of 20 μm to 40 μm. For example, in some embodiments of the present disclosure, the thickness of the ultra-thin glass layer 1 is 20 μm, 25 μm, 30 μm, 35 μm, 40 μm, or the like. An error may be controlled to be ±10 μm. The thickness of the ultra-thin glass layer 1 is set to be 20 μm to 40 μm such that ultra-thin design of the cover plate assembly 100 is implemented, the surface hardness of the cover plate assembly 100 is ensured, the bending performance of the cover plate assembly 100 is improved, problems of creases and flatness are resolved, a bending radius is reduced, and space of an entire apparatus is optimized. Therefore, the cover plate assembly 100 has good bendability and sufficient hardness while being ultra-thin.

In addition, in the display module 1000, the thickness of the ultra-thin glass layer 1 directly affects stress of the ultra-thin glass layer 1 and other film layers of the display module 1000. An increase in the thickness of the ultra-thin glass layer 1 deteriorates the stress. In the display module 1000, only a back film 300 is disposed to protect an inner layer of the display panel 200, and an outer layer of the display panel 200 has more film layers than the inner layer. Therefore, setting the thickness of the ultra-thin glass layer 1 to be 20 μm to 40 μm helps keep the display panel 200 in a neutral layer and avoids failure of the display module 1000 when the display module 1000 is bent.

It should be noted that “outer” in the present disclosure means a side, distal to a display apparatus, of the cover plate assembly 100 when the cover plate assembly 100 is used in the display apparatus. Correspondingly, “inner” in the present disclosure means a side, proximal to the center of the display apparatus, of the cover plate assembly 100 when the cover plate assembly 100 is used in the display apparatus. In the description of the present disclosure, it should be understood that orientations or position relationships indicated by terms such as “inner” and “outer” are orientations or position relationships as shown in the drawings. These terms are merely used to facilitate description of the present disclosure and simplify the description, but not to indicate or imply that the mentioned apparatus or elements must have a specific orientation and must be constructed and operated in a specific orientation. Therefore, these terms cannot be understood as a limitation to the present disclosure.

In some embodiments of the present disclosure, the cover plate assembly 100 further includes a second protection layer 3 disposed on a side, distal to the flat portion, of the ultra-thin glass layer 1. As shown in FIG. 4, the second protection layer 3 is laminated on the ultra-thin glass layer 1. The second protection layer 3 is disposed on the outer side of the ultra-thin glass layer 1. The second protection layer 3 is disposed on the ultra-thin glass layer 1 such that the second protection layer 3 protects the ultra-thin glass layer 1 when the cover plate assembly 100 is impacted by an external force. For example, the second protection layer 3 releases part of the external force through deforming, to reduce the impact of the external force on the ultra-thin glass layer 1. In addition, after the ultra-thin glass layer 1 breaks due to a strong external force, fragments of the ultra-thin glass layer 1 can adhere to the second protection layer 3 to prevent scattering of the fragments from causing harm to the display panel 200 and a user.

In some embodiments of the present disclosure, the second protection layer 3 is a transparent PI member. PI can provide good protection for the ultra-thin glass layer 1. In addition, PI is easy to obtain and has low costs.

In some embodiments of the present disclosure, the second protection layer 3 is attached through an OCA 600. The cover plate assembly 100 in the embodiments is manufactured by coating the OCA 600 on the surface of the ultra-thin glass layer 1, and then coating the second protection layer 3 on the surface of the OCA 600.

The OCA 600 is colorless and transparent, has a light transmittance of more than 90% and a good adhesive strength, can be cured at room temperature or medium temperature, and has small curing shrinkage. The ultra-thin glass layer 1 and the second protection layer 3 adhere to each other through the OCA 600 such that the ultra-thin glass layer 1 and the second protection layer 3 adhere to each other without affecting the display effect of the display module 1000. In addition, the OCA 600 is disposed such that the OCA 600 can also absorb and release part of the external force when the cover plate assembly 100 is impacted by the external force, thereby reducing the impact of the external force on the ultra-thin glass layer 1 and the display panel 200.

In some embodiments of the present disclosure, an anti-fingerprint layer is disposed on a side, distal to the ultra-thin glass layer 1, of the second protection layer 3, thereby improving scratch resistance and the like of the cover plate assembly 100.

The display module 1000 according to some embodiments of a second aspect of the present disclosure includes the cover plate assembly 100 according to the foregoing embodiments of the present disclosure.

In the display module 1000 according to the embodiments of the second aspect of the present disclosure, the cover plate assembly 100 according to the embodiments of the first aspect of the present disclosure is disposed. The first protection layer 2 is disposed on the ultra-thin glass layer 1. The wrap portion 21 of the first protection layer 2 is wrapped around the thinned structure 12 of the ultra-thin glass layer 1. The flat portion 22 of the first protection layer 2 covers the side surface of the ultra-thin glass layer 1. In this way, the reliability and collision resistance of the ultra-thin glass layer 1 are improved, and the risk of edge chipping of the ultra-thin glass layer 1 is reduced. In addition, the overall structural strength of the ultra-thin glass layer 1 is improved, and the falling ball and pen impact resistance of the cover plate assembly 100 is also improved. This helps improve the product strength and service life of the cover plate assembly 100 and the display module 1000 provided with the cover plate assembly 100.

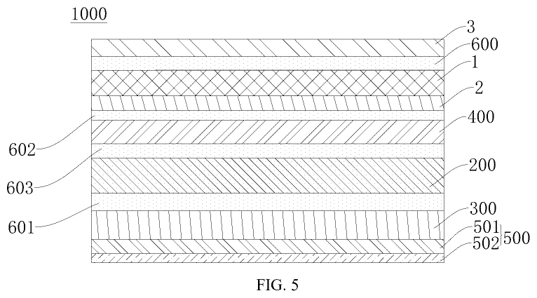

In some embodiments of the present disclosure, as shown in FIG. 5, the display module 1000 further includes the display panel 200 and the back film 300. The display panel 200 is disposed on a side, distal to the ultra-thin glass layer 1, of the flat portion. The back film 300 is disposed on a side, distal to the cover plate assembly 100, of the display panel 200, and is configured to adjust a neutral layer position of the display module 1000 to the display panel 200.

The back film 300 is configured to adjust the neutral layer position of the display module 1000 to the display panel 200 such that stress on the display panel 200 (for example, a thin film transistor (TFT) layer and a packaging layer of the display panel 200) during bending is reduced. Further, the strain of the display panel 200 after the stress is applied during the bending is reduced, to prevent the display panel 200 from being damaged due to failure to satisfy tensile stress and compressive stress. In addition, stress on a connection layer (for example, an adhesive layer) between layers of the display module 1000 is uniform, to avoid failure of the connection layer due to excessive stress. In addition, the display module 1000 is bent with a small radius. For example, folding with a bending radius of R1.5 is implemented.

In some embodiments of the present disclosure, the back film 300 has a thickness of 50 μm to 100 μm and an elastic modulus of 2 GPa to 5 GPa. For example, in some embodiments of the present disclosure, the thickness of the back film 300 is 50 μm, and an error is controlled to be ±10 μm. The elastic modulus of the back film 300 is 3 GPa, and an error is controlled to be ±1 GPa. This can adjust the neutral layer position of the display module 1000 to the display panel 200.

In some embodiments of the present disclosure, the back film 300 adheres to the display panel 200 by a first OCA 601. The first OCA 601 has a thickness of 5 μm to 25 μm and an elastic modulus of 100 kPa to 300 kPa. For example, in some embodiments of the present disclosure, the thickness of the first OCA 601 is 13 μm, and an error is controlled to be ±5 μm. The elastic modulus of the first OCA 601 is 200 kPa, and an error is controlled to be ±50 kPa. This can help adjust the neutral layer position of the display module 1000 to the display panel 200.

In some embodiments of the present disclosure, the first OCA 601 is integrally formed with the back film 300. During manufacturing, the first OCA 601 on the back film 300 directly adheres to the display panel 200, which simplifies the manufacturing process of the display module 1000 and helps improve production efficiency.

In some embodiments of the present disclosure, as shown in FIG. 5, the display module 1000 further includes a circular polarizer (POL) 400. The circular polarizer 400 is disposed between the cover plate assembly 100 and the display panel 200. The circular polarizer 400 includes a linear polarizer and a quarter-wave plate for anti-reflection of the display module 1000. In some embodiments of the present disclosure, the cover plate assembly 100 adheres to the circular polarizer 400 by a second OCA 602, and the circular polarizer 400 adheres to the display panel 200 by a third OCA 603.

The display module 1000 further includes a support member 500. The support member 500 is disposed on a side, distal to the display panel 200, of the back film 300. The support member 500 provides support for the display module 1000. In some embodiments of the present disclosure, the support member 500 includes foam 501 and patterned metal (pattern SUS) 502 that are laminated. The foam is disposed on a side, proximal to the back film 300, of the patterned metal.

A volume of a display apparatus (for example, a mobile phone) is increasingly smaller. For a foldable display apparatus, a smaller bending radius better optimizes a volume of the foldable display apparatus. However, the smaller bending radius results in greater stress on each film layer of the display module 1000. Risks of failure of each film layer and falling off and failure of the connection layer (for example, adhesive layer) increase as the bending radius decreases. In addition, a small bending radius causes creases on the surface of the display module 1000, resulting in an adverse impact on user experience.

In the present disclosure, ultra-thin glass is disposed in the display module 1000 such that the problems of creases and flatness are resolved, the bending radius is reduced, and the space of the entire apparatus is optimized. In addition, in the present disclosure, the neutral layer position of the display module 1000 is adjusted through the back film 300 in the display module 1000 such that the display panel 200 is a neutral layer. Each film layer of the display module 1000 is in a secure range during bending, and stress on each connection layer is uniform, to avoid falling off and failure of the connection layer due to excessive stress.

In the description of this specification, the description with reference to the terms “one embodiment”, “some embodiments”, “an illustrative embodiment”, “an example”, “a specific example”, or “some examples” means that specific features, structures, materials, or characteristics described with reference to the embodiment or example are included in at least one embodiment or example of the present disclosure. In this specification, the schematic representations of the foregoing terms do not necessarily refer to the same embodiment or example. In addition, the specific features, structures, materials, or characteristics described may be combined in any suitable manner in any one or more embodiments or examples.

Although the embodiments of the present disclosure have been illustrated, it should be understood that those of ordinary skill in the art may still make various changes, modifications, replacements, and variations to the foregoing embodiments without departing from the principle and spirit of the present disclosure, and the scope of the present disclosure is limited by the claims and legal equivalents thereof.

1. A display module, comprising a cover plate assembly, wherein the cover plate assembly comprises:
an ultra-thin glass layer, wherein the ultra-thin glass layer comprises a body portion and a thinned structure disposed at a periphery of the body portion; and
a first protection layer, comprising a wrap portion and a flat portion, wherein the flat portion is connected to the wrap portion, the wrap portion is wrapped around the thinned structure of the ultra-thin glass layer, and the flat portion covers a side surface of the body portion of the ultra-thin glass layer;
wherein the wrap portion comprises a first cover section, a connection section, and a second cover section, the first cover section and the second cover section are opposite to each other, and the connection section is between the first cover section and the second cover section;
the first cover section covers a side surface of the thinned structure, the second cover section covers another side surface of the thinned structure, and the connection section covers an edge of the thinned structure; and
in a direction perpendicular to the body portion, a total thickness of the thinned structure and the wrap portion is less than a total thickness of the body portion and the flat portion.

2. The display module according to claim 1, further comprising:
a display panel disposed on a side, distal to the ultra-thin glass layer, of the flat portion; and
a back film disposed on a side, distal to the cover plate assembly, of the display panel cover plate assembly, wherein the back film is configured to adjust a neutral layer position of the display module to the display panel.

3. The display module according to claim 2, wherein the back film has a thickness of 50 μm to 100 μm and an elastic modulus of 2 GPa to 5 GPa.

4. The display module according to claim 3, wherein the back film adheres to the display panel by a first optical clear adhesive (OCA), and the first OCA has a thickness of 5 μm to 25 μm and an elastic modulus of 100 kPa to 300 kPa.

5. The display module according to claim 4, wherein the first OCA is integrally formed with the back film.

6. The display module according to claim 2, further comprising:
a circular polarizer, wherein the circular polarizer is disposed between the cover plate assembly and the display panel.

7. The display module according to claim 6, wherein the circular polarizer comprises a linear polarizer and a quarter-wave plate.

8. The display module according to claim 6, wherein the cover plate assembly adheres to the circular polarizer by a second OCA, and the circular polarizer adheres to the display panel by a third OCA.

9. The display module according to claim 2, further comprising:
a support member, wherein the support member is disposed on a side, distal to the display panel, of the back film.

10. The display module according to claim 9, wherein the support member includes foam and patterned metal that are laminated, and the foam is disposed on a side, proximal to the back film, of the patterned metal.

11. The display module according to claim 1, wherein the first protection layer is coated on the ultra-thin glass layer.

12. The display module according to claim 11, wherein the flat portion has a uniform thickness of 10 μm to 20 μm.

13. The display module according to claim 1, wherein the first protection layer is a transparent polyimide (PI) member.

14. The display module according to claim 1, wherein the ultra-thin glass layer has a thickness of 20 μm to 40 μm.

15. The display module according to claim 1, wherein the cover plate assembly further comprises a second protection layer disposed on a side, distal to the flat portion, of the ultra-thin glass layer.

16. The display module according to claim 15, wherein the second protection layer is a transparent PI member.

17. The display module according to claim 15, wherein the cover plate assembly further comprises an optical clear adhesive (OCA), wherein
the OCA is disposed between the ultra-thin glass layer and the second protection layer and is configured to bond the second protection layer to the ultra-thin glass layer.

18. The display module according to claim 15, wherein the cover plate assembly further an anti-fingerprint layer, and the anti-fingerprint layer is disposed on a side, distal to the ultra-thin glass layer, of the second protection layer.
